(19) United States
(12) Patent Application Publication
(10) Pub. No.: US 2026/0360959 A1
(43) Pub. Date: Nov. 12, 2026

(54) NON-RECIPROCAL CIRCUIT ELEMENT, MANUFACTURING METHOD OF NON-RECIPROCAL CIRCUIT ELEMENT, AND QUANTUM COMPUTER

(71) Applicant: TDK CORPORATION, Tokyo (JP)

(72) Inventors: Nobutaka NISHIO, Tokyo (JP); Hidenori OHATA, Tokyo (JP)

(73) Assignee: TDK CORPORATION, Tokyo (JP)

(21) Appl. No.: 19/652,680

(22) Filed: Apr. 20, 2026

(30) Foreign Application Priority Data
May 9, 2025 (JP) 2025-078701

(51) Int. Cl. H01P 1/36; G06N 10/40

(52) U.S. Cl. CPC H01P 1/36; G06N 10/40

(57) ABSTRACT

The non-reciprocal circuit element 100 has a center conductor, a first magnetic layer, a second magnetic layer, a first housing 41, and a second housing. The center conductor has a first terminal and a second terminal. The center conductor has a first region extending across the first terminal and the second terminal, and a second region different from the first region. The first housing 41 and the second housing have heat exhaust surfaces that dissipate heat generated in the center conductor, the first magnetic layer, and the second magnetic layer. The purity of the metal constituting the first housing 41 and the second housing decreases continuously toward the first terminal, so that the thermal conductivity of the first housing 41 and the second housing decreases continuously toward the first terminal.

### CROSS-REFERENCE TO RELATED APPLICATION

This application claims a priority, under the Paris Convention, to Japanese Patent Application No. 2025-078701 filed on May 9, 2025, the entirety of which is incorporated herein by reference.

### TECHNICAL FIELD

The present disclosure relates to a non-reciprocal circuit element, a manufacturing method of non-reciprocal circuit element, and a quantum computer.

### BACKGROUND

A non-reciprocal circuit element is an element that determines the transmission direction of a high-frequency signal. Isolators and circulators are examples of non-reciprocal circuit elements. Non-reciprocal circuit elements are widely used in circuits that transmit high-frequency signals.

Non-reciprocal circuit elements are used in various places where high-frequency signals are used. For example, International Publication No. 2023/238310 discloses an isolator that uses a band from several GHz to approximately 10 GHz.

Isolators are also used in quantum computers. Among various quantum computers, the superconducting quantum computer, which is currently considered the most promising, requires an isolator that functions at extremely low temperatures because the refrigerator in which the quantum bits are placed is kept at an extremely low temperature (near −273 °C) to accurately measure the quantum bits.

The isolator is placed in the coldest part of the refrigerator in the superconducting quantum computer, closest to the quantum bits.

As recognized by the present inventors, the input terminal of the isolator is connected to the quantum bit processor, and the output terminal is connected to an external terminal in a room temperature environment. If some measure is not taken in the isolator, heat flowing in from the room temperature environment will pass through the isolator and flow into the quantum bit processor. In addition, the isolator generates heat due to its essential functions of insertion loss and isolation. If no measures are taken against this heat, it will flow into the quantum bit processor from the input terminal. This heat significantly deteriorates the signal quality of the quantum bit.

However, the non-reciprocal circuit element disclosed in International Publication No. 2023/238310 is based on the structure of an isolator that functions at room temperature, and there is still room for improvement in heat dissipation in an extremely low temperature environment.

### SUMMARY

One aspect of the present disclosure provides a non-reciprocal circuit element according to this embodiment has a center conductor, a magnetic body, an absorber, and a housing. The center conductor has a first terminal and a second terminal. The center conductor has a first region extending between the first terminal and the second terminal, and a second region different from the first region. The magnetic body overlaps the first region of the center conductor when viewed from the thickness direction. The absorber overlaps the second region of the center conductor when viewed from the thickness direction. The housing has a heat exhaust surface that dissipates heat generated by the center conductor, the magnetic body, and the absorber. The purity of the metal constituting the housing decreases continuously toward the first terminal, so that the thermal conductivity of the housing decreases continuously toward the first terminal.

### BRIEF DESCRIPTION OF DRAWINGS

FIG. 1 shows a cross-sectional view of a non-reciprocal circuit element according to an embodiment of the present disclosure.

FIG. 2 shows a plan view of a non-reciprocal circuit element according to the embodiment of the present disclosure.

FIG. 3 shows a graph showing the temperature dependence of the thermal conductivity of copper for each purity.

FIG. 4 shows a diagram schematically showing an example of the purity gradient of metals in the housing of a non-reciprocal circuit element according to the embodiment of the present disclosure.

FIG. 5 shows a diagram for explaining a manufacturing method of a non-reciprocal circuit element according to the embodiment of the present disclosure.

FIG. 6 shows a graph showing the temperature dependence of the critical magnetic field of various superconductors.

FIG. 7 shows a table showing the thermal conductivity of various materials.

FIG. 8 shows a graph showing the temperature dependence of the thermal conductivity of various materials.

FIG. 9 shows a diagram schematically showing the flow of heat from the magnetic layer of a non-reciprocal circuit element according to the embodiment of the present disclosure toward the housing.

FIG. 10 shows a plan view of a center conductor of a non-reciprocal circuit element according to the embodiment of the present disclosure.

FIG. 11 shows a plan view of the housing and magnet of a non-reciprocal circuit element according to the embodiment of the present disclosure.

FIG. 12 shows a schematic diagram of a quantum computer according to the embodiment of the present disclosure.

### DETAILED DESCRIPTION

The present disclosure provides a non-reciprocal circuit element that can suppress the outflow of heat from a terminal connected to a quantum bit processor in an extremely low temperature environment, a method for manufacturing a non-reciprocal circuit element, and a quantum computer.

Hereinafter, the non-reciprocal circuit element, the manufacturing method of the non-reciprocal circuit element, and the quantum computer according to the present disclosure will be described with reference to the drawings. Here, the dimensional ratios of the components in each drawing do not necessarily match the actual dimensional ratios.

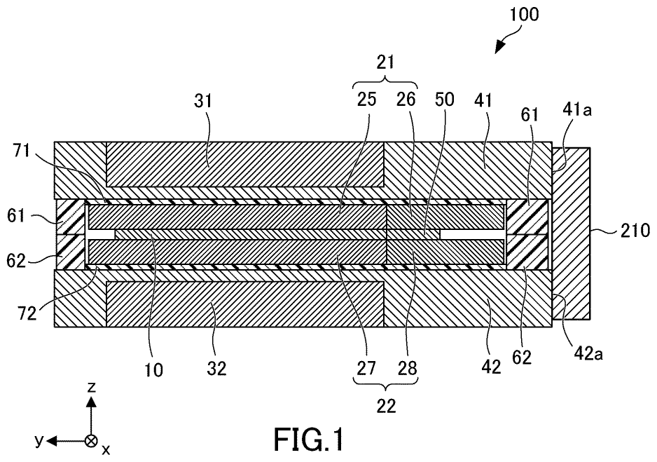

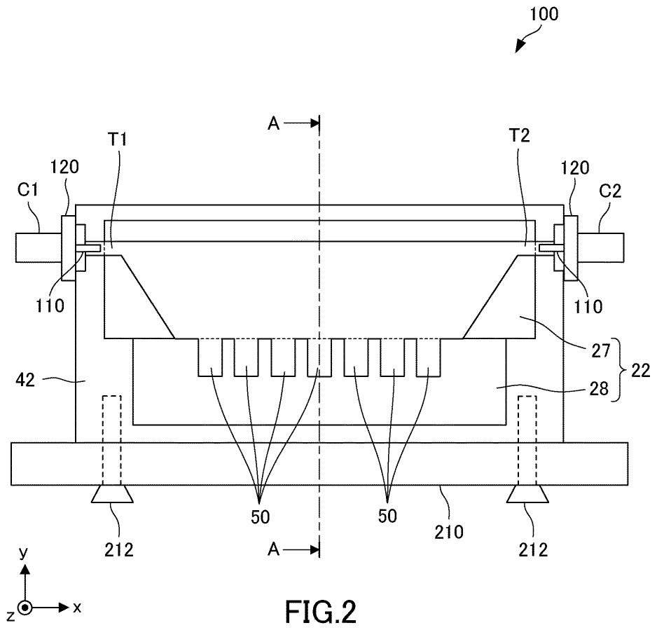

FIG. 1 is a cross-sectional view of a non-reciprocal circuit element 100 according to this embodiment, and FIG. 2 is a plan view of the non-reciprocal circuit element 100 according to this embodiment. FIG. 1 is a cross-sectional view showing a cross section taken along line A-A in FIG. 2.

The non-reciprocal circuit element 100 includes, for example, a center conductor 10, a first magnetic layer 21, a second magnetic layer 22, a first magnet 31, a second magnet 32, a first housing 41, a second housing 42, a first form 61, a second form 62, a coaxial connector C1, and a coaxial connector C2. The non-reciprocal circuit element 100 functions, for example, as an isolator.

In this specification, the direction from the first terminal T1 to the second terminal T2 of the center conductor 10 is defined as the x direction, the direction perpendicular to the x direction on the surface on which the center conductor 10 extends is defined as the y direction, and the direction perpendicular to the x direction and the y direction is defined as the z direction. The thickness direction of each layer is an example of the z direction. In addition, in the z direction, the side on which the first housing 41 exists is defined as the upper side, and the side on which the second housing 42 exists is defined as the lower side.

FIG. 2 is a plan view of the non-reciprocal circuit element 100, excluding the first magnetic layer 21, the first magnet 31, the first housing 41, and the first mold 61, and showing the center conductor 10, the second magnetic layer 22, the second housing 42, and the coaxial connectors C1 and C2 from above. Here, the second mold 62 is not shown in FIG. 2.

The first magnetic layer 21 and the second magnetic layer 22 are disposed on the outside of the center conductor 10, sandwiching the center conductor 10 in the z direction. The first magnetic layer 21 includes a first magnetic body 25 and a first absorber 26. The second magnetic layer 22 includes a second magnetic body 27 and a second absorber 28. The first magnetic layer 21 and the second magnetic layer 22 are substantially the same in shape and are symmetrical with respect to the center conductor 10. The first magnetic layer 21 is between the center conductor 10 and the first magnet 31. The second magnetic layer 22 is between the center conductor 10 and the second magnet 32.

The first housing 41 and the second housing 42 are disposed outside the first magnetic layer 21 and the second magnetic layer 22, respectively, so as to sandwich the first magnetic layer 21 and the second magnetic layer 22 in the z direction. The first housing 41 is sandwiched between the first magnet 31 and the first magnetic layer 21. The second housing 42 is sandwiched between the second magnet 32 and the second magnetic layer 22. The first housing 41 or the second housing 42 is conductive and is connected to, for example, a reference potential. The reference potential is, for example, ground.

As shown in FIG. 1, the first housing 41 has a heat exhaust surface 41a that exhausts heat generated in the center conductor 10 and the first magnetic layer 21. Similarly, the second housing 42 has a heat exhaust surface 42a that exhausts heat generated in the center conductor 10 and the second magnetic layer 22. The heat exhaust surfaces 41a and 42a are parallel to the xz plane.

The heat exhaust surface 41a of the first housing 41 is screwed to the bracket 210 with a screw 212 so as to be in thermal contact with the bracket 210 at a cryogenic temperature in a refrigerator (not shown). Similarly, the heat exhaust surface 42a of the second housing 42 is screwed to the bracket 210 with a screw 212 so as to be in thermal contact with the bracket 210.

The material constituting the first housing 41 and the second housing 42 is, for example, any of metals such as copper (Cu), aluminum (Al), iron (Fe), gold (Au), silver (Ag), platinum (Pt), and palladium (Pd), with copper, aluminum, or iron being particularly preferred. The material constituting the bracket 210 is, for example, copper with a purity of 4N (99.99 % by mass).

The first housing 41 and the first magnetic layer 21 may be bonded with a first adhesive layer 71 made of an insulating adhesive. Similarly, the second housing 42 and the second magnetic layer 22 may be bonded with a second adhesive layer 72 made of an insulating adhesive. If the thermal contact between the first housing 41 and the first magnetic layer 21 and the thermal contact between the second housing 42 and the second magnetic layer 22 are sufficiently ensured, the first adhesive layer 71 and the second adhesive layer 72 may be omitted.

The first adhesive layer 71 and the second adhesive layer 72 have a coefficient of linear expansion of 35×10⁻⁶/K or less at an extremely low temperature of 4 K or less. For the first adhesive layer 71 and the second adhesive layer 72, for example, STYCAST 2850 FT manufactured by Henkel can be suitably used. The linear expansion coefficient of STYCAST 2850 FT is 31×10⁻⁶/K, which is close to the linear expansion coefficient of metals such as aluminum, copper, solder, and brass.

The first adhesive layer 71 and the second adhesive layer 72, which have a linear expansion coefficient close to that of metals, are less likely to peel off from the first housing 41 and the second housing 42, and have excellent adhesion to the first housing 41 and the second housing 42.

The first mold 61 and the second mold 62 are insulating molds provided between the first housing 41 and the second housing 42, and surround the periphery of the first magnetic layer 21 and the second magnetic layer 22, respectively. For example, Teflon (registered trademark) can be suitably used as the first mold 61 and the second mold 62.

The center conductor 10 has a first terminal T1 and a second terminal T2 for inputting and outputting high-frequency signals. The center conductors 110 of the coaxial connectors C1 and C2 are connected to the first terminal T1 and the second terminal T2. The ground conductors 120 of the coaxial connectors C1 and C2 are connected to the first housing 41 and the second housing 42.

The surfaces of the first terminal T1 and the second terminal T2 may be covered with a metal film of any metal, such as nickel (Ni), tin, copper, or silver. For example, these metals are plated on the surfaces of the first terminal T1 and the second terminal T2 to form a metal film, so that when the first terminal T1 and the second terminal T2 are soldered to the center conductors 110 of the coaxial connectors C1 and C2, wettability, connection strength, and conductivity can be ensured.

The center conductor 10 of the non-reciprocal circuit element 100 transmits a high-frequency signal non-reversibly between the first terminal T1 and the second terminal T2. “Transmitting a high-frequency signal non-reversibly” means that the signal propagation efficiency differs depending on the direction. For example, if the center conductor 10 propagates a signal with low loss in the forward direction but hardly propagates a signal in the reverse direction, this corresponds to “transmitting a high-frequency signal non-reversibly”. The propagation direction of the high-frequency signal in the center conductor 10 is controlled by the direction of the DC magnetic field applied to the first magnetic body 25 and the second magnetic body 27.

The high-frequency signal input from the first terminal T1 is transmitted to the second terminal T2 with low loss. Most of the high-frequency signal input from the second terminal T2 is absorbed by the first absorber 26 and the second absorber 28. In other words, almost no high-frequency signal is transmitted from the second terminal T2 to the first terminal T1.

The first terminal T1 is connected to the quantum bit processor 201 of the quantum computer 200 described later, and is an input terminal to which a high-frequency signal is input from the quantum bit processor 201. The second terminal T2 is connected to an external terminal of a refrigerator (not shown), and is an output terminal that outputs a high-frequency signal from the quantum bit processor 201 to the external terminal.

The purity of the metal constituting the first housing 41 and the second housing 42 decreases continuously from the heat exhaust surface 41a, 42a side toward the first terminal T1. Here, “continuously” means that the purity does not change discontinuously or suddenly. Basically, the low purity part has a low thermal conductivity, and the high purity part has a high thermal conductivity, so that heat flows from the low purity part to the high purity part. This is mainly due to the following factors.

Metals mainly conduct heat by the movement of electrons, but high-purity metals have fewer impurities and defects, so the number of times electrons scatter is reduced. This lengthens the mean free path of electrons and increases thermal conductivity. At extremely low temperatures, the energy of lattice vibrations (phonons) in metals decreases and the interaction between electrons and phonons weakens, further reducing electron scattering and improving thermal conductivity.

Therefore, the thermal conductivity of the first housing 41 and the second housing 42 decreases continuously from the heat exhaust surface 41a, 42a side toward the first terminal T1. Here, “continuously” means that the thermal conductivity does not change discontinuously or suddenly.

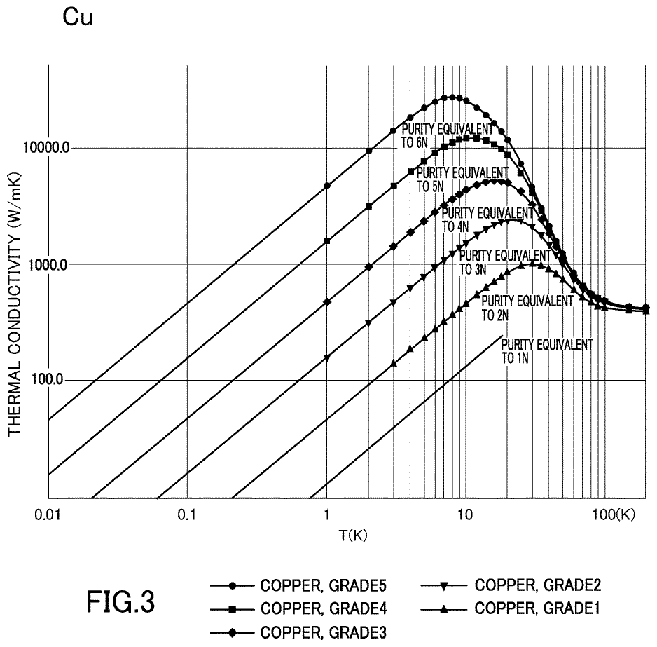

FIG. 3 is a graph showing the temperature dependence of the thermal conductivity of copper, an example of a metal that constitutes the first housing 41 and the second housing 42, for each purity. The data points in this graph are based on the distributed thermal property database of the National Institute of Advanced Industrial Science and Technology (AIST). From this graph, it can be confirmed that at extremely low temperatures below 4K, the higher the purity of copper, the higher the thermal conductivity, and the lower the purity, the lower the thermal conductivity. Specifically, if the purity differs by two orders of magnitude, the thermal conductivity changes by one order of magnitude.

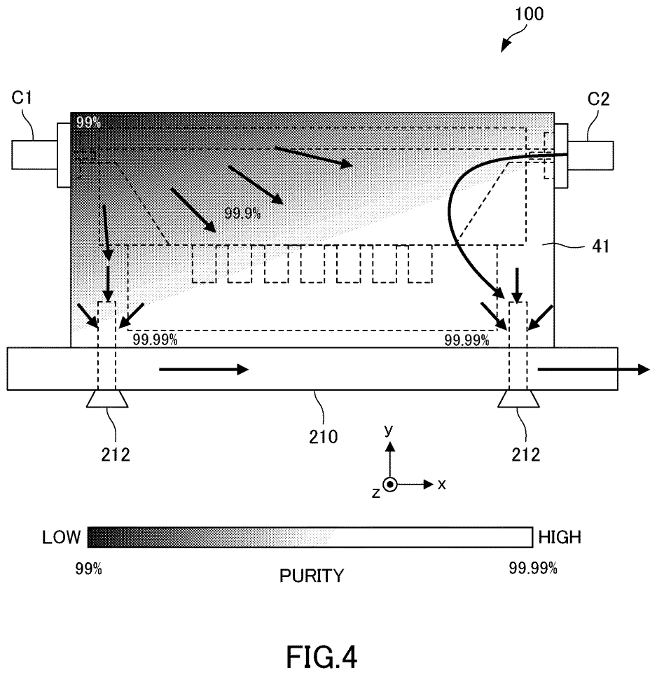

FIG. 4 is a diagram schematically showing an example of a purity gradient of metal in the first housing 41. The arrows in the drawings indicate the direction of heat flow. Here, the first magnet 31 and the first adhesive layer 71 are omitted in FIG. 4. The example in FIG. 4 shows an example in which a purity gradient is provided in one direction along the diagonal of the first housing 41, which is rectangular when viewed from the z direction. Specifically, the purity of the first housing 41 increases from the upper left to the lower right of the figure, being 99% by mass near the first terminal T1, 99.9% by mass in the middle, and 99.99% by mass at the screwed portion with the bracket 210. Therefore, heat flowing in from the second terminal T2 side does not go to the first terminal T1 side, but is guided to the screwed portion by the screw 212.

Although not shown in the drawings, the second housing 42 is also provided with a purity gradient similar to that of the first housing 41. In this way, by providing a purity gradient to the metals constituting the first housing 41 and the second housing 42, it is possible to continuously change the thermal conductivity and form a heat exhaust path toward the bracket 210.

Here, the purity gradient provided in the first housing 41 and the second housing 42 is not limited to the one direction along the diagonal line described above, but may be provided in one direction from the first terminal T1 side toward the second terminal T2 side. Alternatively, the purity gradient provided in the first housing 41 and the second housing 42 may be provided radially in multiple directions from the first terminal T1 side.

The width of the purity gradient is preferably two or more digits in weight percent, but may be one digit. The purity gradient may also be linear or exponential.

As will be described later, heat generated in the first magnetic layer 21 and the second magnetic layer 22 also passes through the first housing 41 and the second housing 42, and is not guided to the first terminal T1 side, but is guided to the screw-fastened portion by the screw 212, and is exhausted from the screw-fastened portion through the bracket 210 to the outside.

By configuring the first housing 41 and the second housing 42 in this way, the non-reciprocal circuit element 100 according to this embodiment can improve heat exhausting properties and reduce Johnson noise (thermal noise). Therefore, when the non-reciprocal circuit element 100 is used in the quantum computer 200, it can suppress the conduction of heat to the quantum bit processor 201 and contribute to accurate measurement of quantum bits.

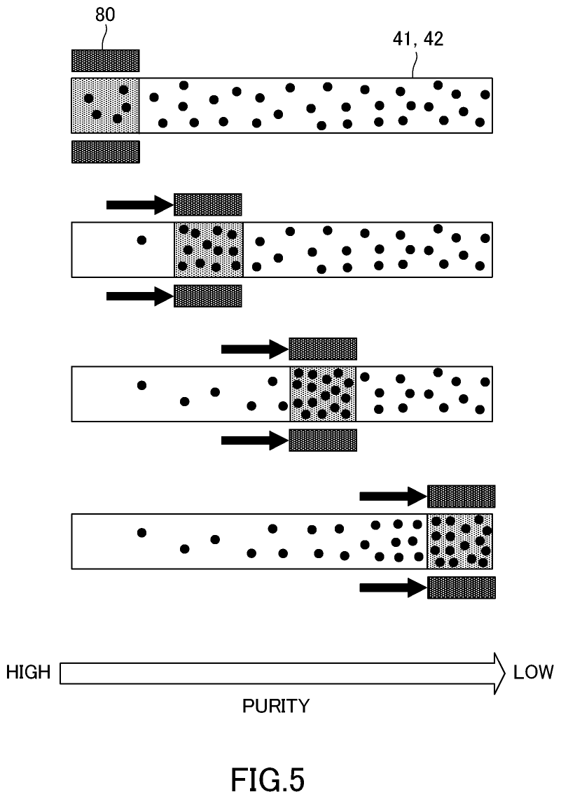

As a method for providing a purity gradient to the first housing 41 and the second housing 42, for example, a zone melting method can be used. As shown in FIG. 5, first, a heater 80 is placed so as to cover the periphery of one end of the first housing 41 and the second housing 42. The first housing 41 and the second housing 42 are heated to their melting points by the heater 80, and the temperature is controlled within a range in which deformation due to melting does not occur. When the heater 80 is gradually moved toward the opposite side of the first housing 41 and the second housing 42, impurities move from the part that solidifies after heating to the part that newly melts due to heating.

In the normal zone melting method, impurities are aggregated at one end of the metal. In the present disclosure, the impurity concentration in the first housing 41 and the second housing 42 is continuously changed by appropriately controlling the temperature, temperature distribution, moving speed, heater stop position, etc., of the heater 80.

In this way, the manufacturing method of the non-reciprocal circuit element 100 according to this embodiment performs heat treatment using the zone melt method on the first housing 41 and the second housing 42, which are made of the same metal solid, so that the purity of the metal constituting the first housing 41 and the second housing 42 can be continuously decreased as it approaches the first terminal T1.

The center conductor 10 may be any metal capable of transmitting high-frequency signals with high efficiency, such as aluminum, copper, silver, gold, stainless steel (SUS), or beryllium copper (BeCu). The center conductor 10 may be a non-conductor or a conductor with high resistance (such as phosphor bronze) plated with aluminum, copper, silver, gold, or stainless steel.

Alternatively, at least a portion of the center conductor 10 may be a superconductor that exhibits superconductivity at cryogenic temperatures of 4K or less, such as a type-II superconductor such as niobium titanium (NbTi) or niobium tin (Nb₃Sn).

Type-II superconductors have a lower thermal conductivity at cryogenic temperatures than type-I superconductors made of single-element metals such as aluminum, tantalum (Ta), and lead (Pb), and metals such as copper, silver, and iron. This is mainly because type-II superconductors are generally composed of compounds, and the mean free path of electrons becomes shorter due to the influence of the crystal structure and impurities.

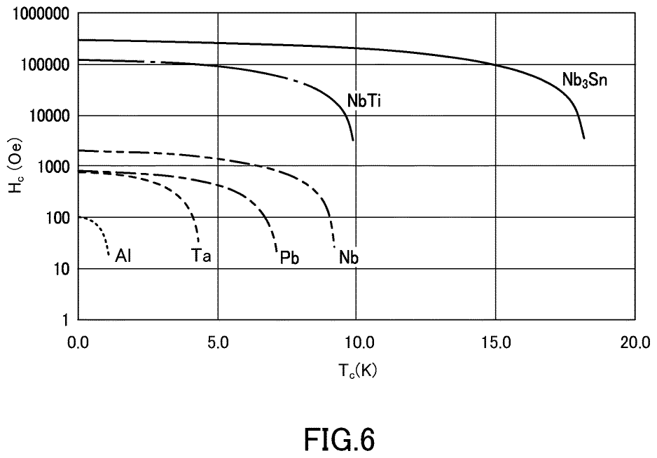

FIG. 6 is a graph showing the temperature dependence of the critical magnetic field H_{c} for various superconductors. NbTi and Nb₃Sn have a critical magnetic field H_{c} of 100,000 Oe or more at extremely low temperatures below 4K, which is much higher than the critical magnetic fields H_{c} of aluminum, niobium (Nb), tantalum, lead, etc. However, the critical magnetic field H_{c} of type-II superconductors NbTi, Nb₃Sn, and Nb is the upper critical magnetic field H_{c2}.

The center conductor 10 is driven in the magnetic field sandwiched between the first magnet 31 and the second magnet 32, and the strength of the magnetic field is, for example, about 1750 Oe. If the critical magnetic field H_{c} of the superconductor is smaller than this magnetic field, the superconducting state is destroyed and the superconducting state is restored, losing the advantage of almost zero resistance at extremely low temperatures. NbTi and Nb₃Sn can maintain their superconducting state because their critical magnetic field H_{c} is much higher than 1750 Oe.

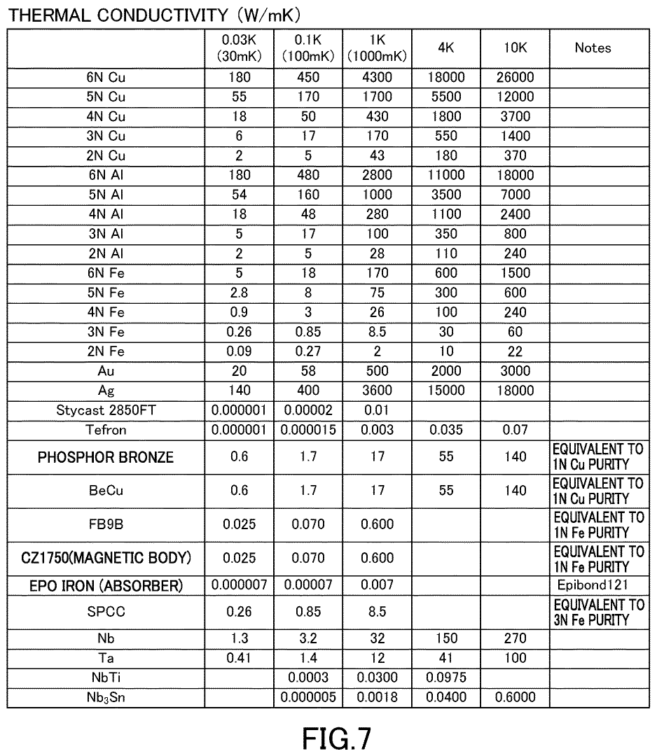

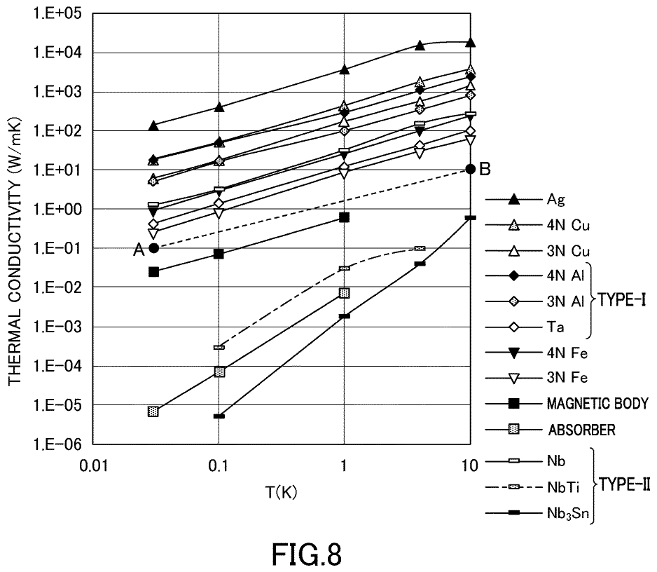

FIG. 7 is a table showing the thermal conductivity of various materials. FIG. 8 is a graph showing the temperature dependence of the thermal conductivity of some of the materials listed in the table of FIG. 7, the first magnetic body 25 and the second magnetic body 27 (magnetic body), and the first absorber 26 and the second absorber 28 (absorber).

From FIGS. 7 and 8, it can be seen that the higher the purity of copper, aluminum, and iron, the higher the thermal conductivity. Also, when compared at the same purity, copper has a better thermal conductivity than aluminum. The thermal conductivity of iron is one to two orders of magnitude lower than that of copper and aluminum.

In the conventional isolators, for example, phosphor bronze plated with silver is used as the center conductor. Since the thermal conductivity of silver is 4 to 8 orders of magnitude larger than that of the magnetic body and absorber sandwiching the center conductor, it is considered that the heat generated in the center conductor, magnetic body, and absorber is transferred from the center conductor to the input terminal close to the quantum bit processor.

Therefore, in the non-reciprocal circuit element 100 according to this embodiment, it is preferable that the center conductor 10 is a type-II superconductor with a thermal conductivity of 10 W/mK or less in a temperature range of 10 K or less. Furthermore, it is preferable that the center conductor 10 is a type-II superconductor with a thermal conductivity of 0.1 W/mK at 30 mK and 10 W/mK at 10 K in the graph of FIG. 8. That is, the thermal conductivity of the type-II superconductor constituting the center conductor 10 is preferably equal to or less than Y, which is expressed by Y=1.6116X^{0.7927}, where X is a temperature in the range of 0.03 K to 10 K.

NbTi and Nb₃Sn are type-II superconductors having a thermal conductivity equal to or less than Y. Since NbTi and Nb₃Sn have a smaller thermal conductivity than copper, aluminum, or iron constituting the first housing 41 and the second housing 42, by forming the center conductor 10 from NbTi or Nb₃Sn, it is possible to control the heat exhaust path so that heat does not flow from the first terminal T1 to the quantum bit processor 201 through the coaxial connector C1.

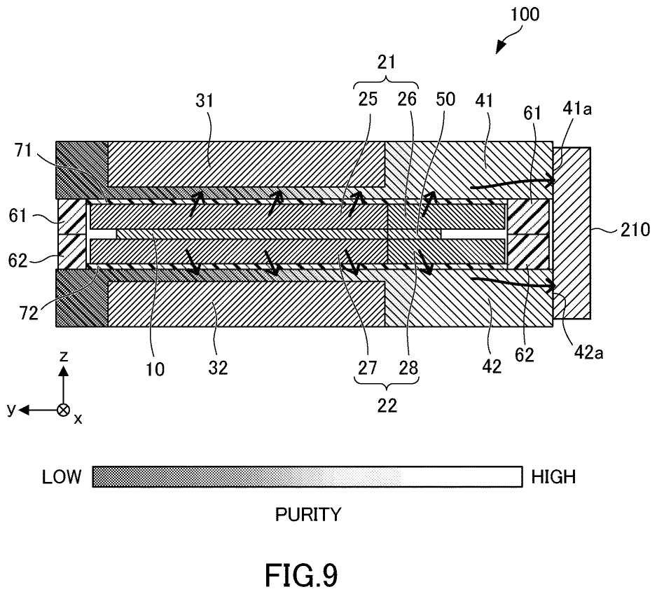

FIG. 9 is a diagram schematically showing, using arrows, the flow of heat from the first magnetic layer 21 and the second magnetic layer 22 to the first housing 41 and the second housing 42. The thermal conductivity of the center conductor 10 is smaller than that of the first housing 41 and the second housing 42, so that the heat generated in the first magnetic layer 21 and the second magnetic layer 22 is not conducted to the center conductor 10, but is conducted to the first housing 41 and the second housing 42. Furthermore, the first housing 41 and the second housing 42 are provided with a purity gradient as shown in FIG. 4, so that a heat exhaust path is formed in which the heat conducted to the first housing 41 and the second housing 42 passes through the first housing 41 and the second housing 42 and falls to the bracket 210.

As shown in FIG. 6, NbTi and Nb₃Sn have a larger critical magnetic field H_{c} than type-I superconductors such as aluminum and tantalum, so that the range in which the superconducting state can be maintained in a magnetic field can be widened. This makes it possible to improve the high-frequency characteristics of the non-reciprocal circuit element 100 having the center conductor 10 made of NbTi or Nb₃Sn. Furthermore, since the resistance of the center conductor 10 becomes almost zero at extremely low temperatures and the generation of heat (I²×R) is suppressed, the conduction of heat to the quantum bit processor 201 through the first terminal T1 can be suppressed.

The non-reciprocal circuit element 100 configured in this manner can reduce Johnson noise (thermal noise). Therefore, when the non-reciprocal circuit element 100 is used in the quantum computer 200, it can improve the signal quality of the quantum bit and contribute to accurate measurement of the quantum bit.

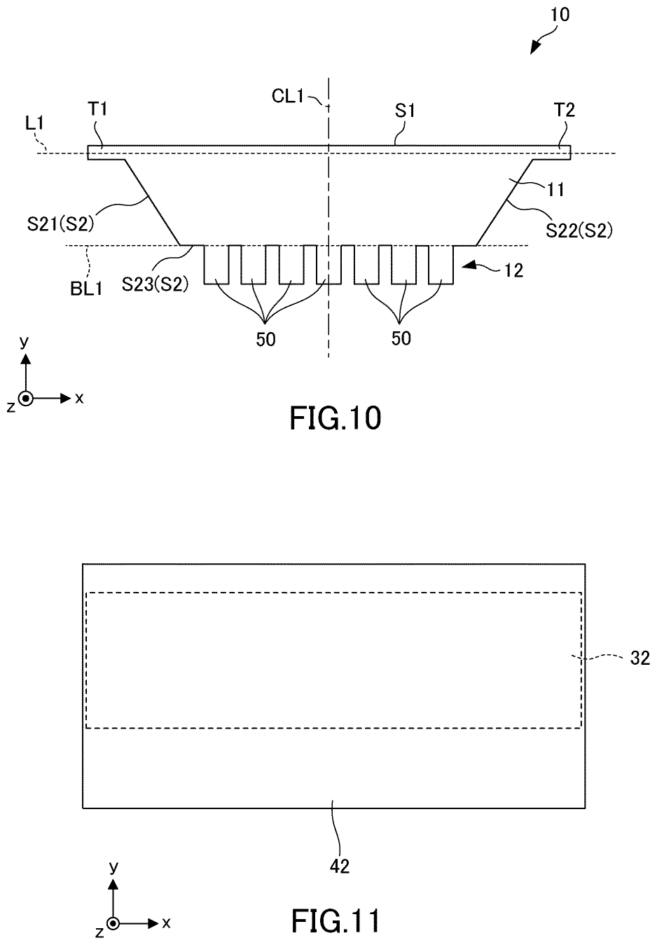

As shown in FIG. 10, the center conductor 10 has a first region 11 and a second region 12 different from the first region 11. The center conductor 10 may have a region other than the first region 11 and the second region 12. The first region 11 is a region that overlaps with the first magnetic body 25 and the second magnetic body 27 when viewed from the z direction. The first region 11 extends across the first terminal T1 and the second terminal T2. The first region 11 is sandwiched between the first magnetic body 25 and the second magnetic body 27 in the z direction. The second region 12 is a region that overlaps with the first absorber 26 and the second absorber 28 when viewed from the z direction. The second region 12 is sandwiched between the first absorber 26 and the second absorber 28 in the z direction. The boundary BL1 between the first region 11 and the second region 12 coincides with both the boundary between the first magnetic body 25 and the first absorber 26 and the boundary between the second magnetic body 27 and the second absorber 28 when viewed from the z direction.

The center conductor 10 has a first connection line S1 and a second connection line S2 on its outer periphery when viewed from the z direction. The first connection line S1 and the second connection line S2 are lines that connect the first terminal T1 and the second terminal T2, respectively. The first connection line S1 and the second connection line S2 join together to form the outer periphery of the center conductor 10 when viewed from the z direction.

The first connection line S1 is one side of the first region 11. The first connection line S1 may be a straight line or a curved line. In the example shown in FIG. 10, the first connection line S1 is a straight line that is parallel to the straight line L1 that connects the first terminal T1 and the second terminal T2.

The second connection line S2 has, for example, a first side S21 and a second side S22 in the first region 11, and a third side S23 that is on the boundary BL1 between the first region 11 and the second region 12. The first side S21, the second side S22, and the third side S23 may be straight or curved.

The center conductor 10 is, for example, symmetrical in the x direction with respect to the center line CL1. The center line CL1 is a line that passes through the center of the straight line connecting the first terminal T1 and the second terminal T2 and is perpendicular to the straight line.

The center conductor 10 has a resonator 50 in the second region 12. The resonator 50 confines a part of the high-frequency signal propagating along the second connection line S2 within a certain space. The resonator 50 is within a range that the high-frequency signal propagating along the second connection line S2 can reach. The resonator 50 is, for example, connected to the center conductor 10. The resonator 50 and the center conductor 10 may be integrated, or may be separate bodies electrically connected to each other. The resonator 50 is, for example, one or more protrusions protruding from the third side S23.

The resonator 50 shown in FIG. 10 is a quarter-wavelength resonator. The quarter-wavelength resonator satisfies the following equation (1).

L≤¼f₀(ϵ₀μ₀ϵ_{γ}μ_{γ})^{1/2} (1)

In the equation (1), L is the length of the quarter-wavelength resonator, f₀ is the resonant frequency, ϵ₀ is the dielectric constant of a vacuum, μ₀ is the magnetic permeability of a vacuum, ϵ_{γ}is the dielectric constant of the first absorber 26 and the second absorber 28, and μ_{γ}is the magnetic permeability of the first absorber 26 and the second absorber 28. When the length L of the resonator 50 satisfies an integer multiple of the quarter-wavelength of the high frequency propagating along the second connection line S2, the resonator 50 confines the high frequency signal. The length L is the length of the resonator 50 in the protruding direction from the third side S23.

When viewed from the z direction, the resonator 50 overlaps with the first absorber 26 and the second absorber 28. The resonator 50 is sandwiched between the first absorber 26 and the second absorber 28 in the z direction.

The resonator 50 is made of a conductor. For example, the same material as the center conductor 10 can be used for the resonator 50.

The resonator 50 shown in FIG. 10 is symmetrical in the x direction with respect to the center line CL1, for example. The resonator 50 symmetrical with respect to the center line CL1 is easy to form, and the resonator 50 symmetrical with respect to the center line CL1 is highly versatile.

The first magnetic body 25 and the first absorber 26 are at different positions in the xy plane when viewed from the z direction. Similarly, the second magnetic body 27 and the second absorber 28 are at different positions in the xy plane when viewed from the z direction. The first magnetic body 25 and the second magnetic body 27 are at positions overlapping the first region 11 of the center conductor 10 in the z direction. The first magnetic body 25 and the second magnetic body 27 sandwich the first region 11 in the z direction. The first absorber 26 and the second absorber 28 are at positions overlapping the resonator 50 in the second region 12 of the center conductor 10 in the z direction. The first absorber 26 and the second absorber 28 sandwich the resonator 50 in the second region 12 in the z direction.

The first magnetic body 25 and the second magnetic body 27 may have any shape as long as the first magnetic body 25 and the second magnetic body 27 can cover the first region 11. The first absorber 26 and the second absorber 28 may have any shape as long as the first absorber 26 and the second absorber 28 can cover the resonator 50 in the second region 12. For example, as shown in FIG. 2, the first magnetic body 25 and the first absorber 26 may both have a rectangular shape when viewed from the z direction.

When a DC magnetic field is applied to the first magnetic body 25 and the second magnetic body 27, the high-frequency signal passing through the center conductor 10 propagates with a deviation to one side of the traveling direction. For example, the high-frequency signal input from the first terminal T1 is shifted to the vicinity of the first connection line S1 and propagates along the first connection line S1 to the second terminal T2.

On the other hand, the high-frequency signal input to the second terminal T2 is shifted to the vicinity of the second connection line S2 and propagates along the second connection line S2 to the first terminal T1. At this time, the high-frequency signal input to the second terminal T2 is absorbed by the first absorber 26 and the second absorber 28 and is greatly attenuated. In addition, the high-frequency signal input to the second terminal T2 is trapped by the resonator 50, and the intensity of the high-frequency signal trapped by the resonator 50 is greatly attenuated.

The first magnetic body 25 and the second magnetic body 27 include a magnetic material. The first magnetic body 25 and the second magnetic body 27 may be a conductor or an insulator. The first magnetic body 25 and the second magnetic body 27 are, for example, soft magnetic bodies. The first magnetic body 25 and the second magnetic body 27 include, for example, any one selected from the group consisting of Co-based amorphous, ferrite, Fe₈₅Si₂B₈P₄Cu, Fe₈₆AlB₈P₄Cu, Fe₇₈Si₉B₁₃, and yttrium iron garnet (YIG). YIG is, for example, Y₃Fe₂(FeO₄)₃ and Y₃Fe₅O₁₂.

The first magnetic body 25 and the second magnetic body 27 may be a mixture of magnetic particles and resin. The magnetic particles include, for example, iron, silicon steel (Fe—Si), permalloy (Ni—Fe), permendur (Fe—Co), sendust (Fe—Si—Al), electromagnetic stainless steel, amorphous iron-based alloys (Fe—B—C-based, Fe—Co-based), manganese zinc ferrite, nickel zinc ferrite, etc. The first magnetic body 25 and the second magnetic body 27 may be a mixture of ferrite particles and resin.

When dispersing a magnetic material in an insulating material (e.g., resin, rubber, paint, etc.), it is preferable that the volume ratio of the magnetic material is 10% or more and 70% or less. If the volume ratio of the magnetic material is small, the electromagnetic wave absorption capacity becomes small. If the volume ratio of the magnetic material is high, it becomes difficult to disperse it in the insulating material.

The first absorber 26 and the second absorber 28 include a material having a larger magnetic loss than the first magnetic body 25 and the second magnetic body 27. The first absorber 26 and the second absorber 28 include, for example, any one selected from the group consisting of iron, BN, conductive carbon, SiC, and Ni-based ferrite.

If the first magnetic layer 21 and the second magnetic layer 22 are conductors, an insulating layer is provided between the first magnetic layer 21 and the center conductor 10 and between the second magnetic layer 22 and the center conductor 10. A publicly known insulating layer can be used.

The first magnet 31 and the second magnet 32 sandwich the center conductor 10, the first magnetic layer 21, and the second magnetic layer 22 in the z direction. The first magnet 31 and the center conductor 10 sandwich the first magnetic layer 21 in the z direction. The second magnet 32 and the center conductor 10 sandwich the second magnetic layer 22 in the z direction. The first magnet 31 and the second magnet 32 apply a DC magnetic field to the first magnetic body 25 and the second magnetic body 27.

FIG. 11 is a plan view of the second housing 42 and the second magnet 32 from above. The first magnet 31 and the second magnet 32 are positioned so as to overlap the first magnetic body 25 and the second magnetic body 27 when viewed from the z direction. Parts of the first magnet 31 and the second magnet 32 may overlap the first absorber 26 and the second absorber 28 when viewed from the z direction.

The first magnet 31 and the second magnet 32 are, for example, hard magnetic materials. The first magnet 31 and the second magnet 32 may be insulators or conductors. The first magnet 31 and the second magnet 32 include, for example, any one selected from the group consisting of an insulating ferrite magnet, a conductive rare earth magnet, TbFeCo, GdFeCo, SmFeCo, NdFeB, a [Co/Pt] multilayer film, and a [Co/Pd] multilayer film. If the first magnet 31 and the second magnet 32 are conductive, the first housing 41 and the second housing 42 may be omitted.

The first magnet 31 and the second magnet 32 are an example of a magnetic field source. The magnetic field source is not limited to the first magnet 31 and the second magnet 32 as long as the magnetic field source can apply a DC magnetic field to the first magnetic body 25 and the second magnetic body 27 through the first housing 41 and the second housing 42, respectively.

The non-reciprocal circuit element 100 according to this embodiment has excellent isolation characteristics by having the resonator 50. The resonator 50 confines a part of the high-frequency signal input from the second terminal T2 within the resonator 50, preventing the high-frequency signal input from the second terminal T2 from reaching the first terminal T1. The smaller the intensity of the high-frequency signal reaching the first terminal T1 from the second terminal T2, the higher the isolation characteristic of the non-reciprocal circuit element 100.

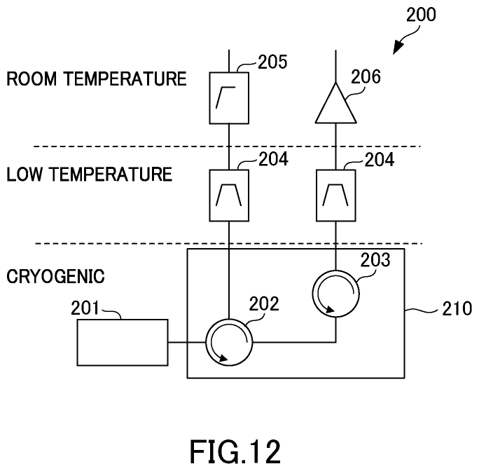

The non-reciprocal circuit element 100 according to this embodiment can be applied to, for example, a quantum computer. FIG. 12 is a schematic diagram of the quantum computer according to this embodiment. The quantum computer 200 includes, for example, a quantum bit processor 201, non-reciprocal circuit elements 202 and 203, filters 204 and 205, and an amplifier 206.

The quantum bit processor 201 performs quantum calculations. The non-reciprocal circuit elements 202 and 203 are attached to the bracket 210 so as to be in thermal contact with the bracket 210, and deliver a quantum bit read signal from the quantum bit processor 201. The non-reciprocal circuit element 202 is a circulator. The non-reciprocal circuit element 203 is an isolator. The non-reciprocal circuit element 100 according to the present embodiment can be applied to the non-reciprocal circuit element 203. The amplifier 206 amplifies the read signal.

The first terminal T1 of the non-reciprocal circuit element 100 (203) is connected to the quantum bit processor 201 through the non-reciprocal circuit element 202.

For example, a superconducting quantum computer operates at extremely low temperatures. Therefore, the quantum bit processor 201 and the non-reciprocal circuit elements 202 and 203 are also placed in positions exposed to an extremely low temperature environment. Since it is difficult to maintain a large volume of space in an extremely low temperature environment, miniaturization of the non-reciprocal circuit elements 202, 203 is required. The non-reciprocal circuit element 100 according to this embodiment is small in size and does not allow heat to flow from the first terminal T1 to the quantum bit processor 201, so that high performance and stable operation of the quantum computer can be achieved.

Although the disclosure has been described with respect to only a limited number of embodiments, those skilled in the art, having benefit of this disclosure, will appreciate that various other embodiments may be devised without departing from the spirit and scope of the present disclosure. Accordingly, the technical scope of the disclosed subject matter should be limited only by the attached claims.

### DESCRIPTION OF REFERENCE NUMERALS AND SIGNS

10 Center conductor
11 First region
12 Second region
21 First magnetic layer
22 Second magnetic layer
25 First magnetic body
26 First absorber
27 Second magnetic body
28 Second absorber
31 First magnet
32 Second magnet
41 First housing
41a Heat exhaust surface
42 Second housing
42a Heat exhaust surface
50 Resonator
61 First mold
62 Second mold
71 First adhesive layer
72 Second adhesive layer
100 Non-reciprocal circuit element
200 Quantum computer
201 Quantum bit processor
202, 203 Non-reciprocal circuit element
204, 205 Filter
206 Amplifier
210 Bracket
S1 First connection line
S2 Second connection line
S21 First side
S22 Second side
S23 Third side
T1 First terminal
T2 Second terminal

What is claimed is:

1. A non-reciprocal circuit element comprising a center conductor, a magnetic body, an absorber, and a housing, wherein
the center conductor having a first terminal and a second terminal,
the center conductor having a first region extending across the first terminal and the second terminal, and a second region different from the first region,
the magnetic body overlaps the first region of the center conductor when viewed in the thickness direction,
the absorber overlaps the second region of the center conductor when viewed in the thickness direction,
the housing has a heat exhaust surface for exhausting heat generated by the center conductor, the magnetic body, and the absorber,
the purity of the metal constituting the housing decreases continuously toward the first terminal, and
the thermal conductivity of the housing decreases continuously toward the first terminal.

2. The non-reciprocal circuit element according to claim 1, wherein
a shape of the housing as viewed in a thickness direction thereof is rectangular, and
a purity gradient of the metal is provided in one direction along a diagonal line of the housing.

3. The non-reciprocal circuit element according to claim 1, wherein
a shape of the housing as viewed in a thickness direction thereof is rectangular, and
a purity gradient of the metal is provided in one direction from the first terminal toward the second terminal.

4. The non-reciprocal circuit element according to claim 1, wherein
a shape of the housing as viewed in a thickness direction thereof is rectangular, and
a purity gradient of the metal is provided in a plurality of radial directions from the first terminal.

5. The non-reciprocal circuit element according to claim 1, wherein
the first terminal is an input terminal to which a high-frequency signal is input, and
the second terminal is an output terminal that outputs the high-frequency signal to an external terminal.

6. The non-reciprocal circuit element according to claim 1, wherein
the housing is conductive and is connected to a reference potential.

7. The non-reciprocal circuit element according to claim 1, wherein
the housing is made of any one of metals including copper, aluminum, iron, gold, silver, platinum, and palladium.

8. The non-reciprocal circuit element according to claim 1, wherein
the housing, the magnetic body, and the absorber are bonded together by an adhesive layer made of an insulating adhesive.

9. The non-reciprocal circuit element according to claim 8, wherein
the adhesive layer has a coefficient of linear expansion of 35×10⁻⁶/K or less at an extremely low temperature of 4 K or lower.

10. The non-reciprocal circuit element according to claim 1, wherein
surfaces of the first terminal and the second terminal are covered with a metal film.

11. The non-reciprocal circuit element according to claim 1, wherein at least a portion of the center conductor is a type-II superconductor.

12. The non-reciprocal circuit element according to claim 11, wherein
the thermal conductivity of the type-II superconductor constituting the center conductor is equal to or less than Y, expressed as Y=1.6116X^{0.7927}, where X is a temperature in the range of 0.03 K to 10 K.

13. The non-reciprocal circuit element according to claim 11, wherein
the type-II superconductor is NbTi or Nb₃Sn.

14. The non-reciprocal circuit element according to claim 1, further comprising a resonator that overlaps the absorber when viewed in the thickness direction.

15. The non-reciprocal circuit element according to claim 14, wherein
the resonator is one or more protrusions protruding from one side of the second region of the center conductor.

16. The non-reciprocal circuit element according to claim 14, wherein
the resonator is a quarter-wavelength resonator.

17. The non-reciprocal circuit element according to claim 1, further comprising an insulating mold that surrounds the magnetic body and the absorber.

18. A method for manufacturing a non-reciprocal circuit element according to claim 1, comprising the step of using a zone melting method by which the purity of the metal constituting the housing is continuously decreased toward the first terminal.

19. A quantum computer comprising: the non-reciprocal circuit element according to claim 1; and a quantum bit processor connected to the first terminal of the non-reciprocal circuit element.

20. The quantum computer according to claim 19, wherein
the non-reciprocal circuit element is an isolator.
